(19) United States
(12) Patent Application Publication
(10) Pub. No.: US 2025/0061901 A1
(43) Pub. Date: Feb. 20, 2025

(54) MULTI CHANNEL AUDIO PROCESSING FOR UPMIXING/REMIXING/DOWNMIXING APPLICATIONS

(71) Applicant: DIRAC RESEARCH AB, Uppsala (SE)

(72) Inventors: Søren Skovgaard Christensen, Dyssegaard (DK); Pedro Højen-Sørensen, Allerød (DK); Morten Rolle Hansen, Hellerup (DK); Denys Volkov, Uppsala (SE); Lars-Johan Brännmark, Uppsala (SE)

(73) Assignee: DIRAC RESEARCH AB, Uppsala (SE)

(21) Appl. No.: 18/719,715

(22) PCT Filed: Dec. 20, 2022
(86) PCT No.: PCT/EP2022/086902

§ 371 Date: Jun. 14, 2024

Related U.S. Application Data
(60) Provisional application No. 63/291,647, filed on Dec. 20, 2021.

(51) Int. Cl. G10L 19/008; G10L 19/02

(52) U.S. Cl. CPC G10L 19/008; G10L 19/0204

(57) ABSTRACT

A method for determining a decoding L×K matrix for decoding incoming L-dimensional channel audio into outgoing K-dimensional channel audio where L≥2 and K≥1 is provided. The method comprising: determining a panning control parameter p and a sample component d that minimizes a first difference metric between an L-dimensional input sample x and an estimation of the input sample x^{est}=d a, where a=A(p) and where A(p) is a first pre-set mapping function that returns an L-dimensional panning vector a for a given panning control parameter p; generating a K-dimensional raw output sample y^{raw}=d s, where s=S(p) and where S(p) is a second pre-set mapping function that returns a K-dimensional panning vector s for a given panning control parameter p, and; determining the decoding L×K matrix M by solving an optimization problem that minimizes a second difference metric between the K-dimensional raw output sample y^{raw} and the decoded input sample x M. A method for decoding incoming L-dimensional channel audio into outgoing K-dimensional channel audio using the decoding L×K matrix is also provided.

### TECHNICAL FIELD

The proposed technology generally relates to audio processing, and more particularly to a method and system for multi-channel audio processing for upmixing/remixing/downmixing applications, an adaptive spatial decoder, an audio processing system as well as a corresponding overall audio system and a computer program and computer-program product.

### BACKGROUND

Multi-channel audio processing is widely used in many different audio applications. More specifically, multi-channel processing is commonly used for upmixing/remixing/downmixing applications.

By way of example, it is well-known to provide upmixing for generating a multi-channel audio signal from stereo recordings, e.g. see “A Frequency-Domain Approach to Multichannel Upmix” by Avendano et al., J. Audio Eng. Soc., Vol. 52, No. 7/8, July/August 2004, “Multiple-Loudspeaker Playback of Stereo Signals” by Faller, J. Audio Eng. Soc., Vol. 54, No. 11, November 2006, and U.S. Pat. No. 8,280,077. The concept of multi-channel upmixing is sometimes referred to as multiple-loudspeaker playback of stereo signals.

Information on specific techniques for upmixing as well as so-called stream segregation and multi-channel audio decomposition are disclosed e.g. in U.S. Pat. Nos. 9,088,855, 8,204,237, 8,019,093, 7,315,624, 7,257,231, US Patent Application Publication No. 2011/0081024, EP 2517485 B1, WO 2015/169618 A1, and “Direct-Ambient Decomposition and Upmix of Surround Signals” by Walther et al., 2011 IEEE Workshop on Application of Signal Processing to Audio and Acoustics, October 2011. Even though there are audio recordings available in multi-channel format, most recordings are still mixed into two channels and playback of this material over a multi-channel system poses several challenges. Typically, audio engineers mix stereo recordings with a particular setup in mind, namely a pair of loudspeakers placed symmetrically in front of the listener. Accordingly, listening to this kind of material over a multi-speaker system (e.g. 5.1 surround) raises questions like which signal(s) should be sent to the surround and center channels. Unfortunately, no clear objective criteria exist.

Normally, there are two main approaches for mixing multi-channel audio. One is the direct/ambient approach, in which the main signals (e.g. relating to instruments) are panned among the front channels in a front-oriented fashion as is commonly done with stereo mixes, and so-called “ambience” signals are sent to the rear (surround) channels. Such a mix creates the impression that the listener is in the audience, in front of the stage. The second approach is the sources-all-around or in-the-band approach, where the instrument and ambience signals are panned among all the loudspeakers, creating the impression that the listener is surrounded by the musicians, e.g. see “Surround Sound: Up and Running” 2nd Ed. by Tomlinson Holman, Focal Press, 2008. There is still an ongoing debate about which approach is the best.

Irrespective of whether an in-the-band or a direct/ambient approach is adopted, there is a general demand for improved signal processing techniques to manipulate a stereo recording to extract signal components associated with different panning settings as well as the ambience signals. This is a very difficult task since no or very limited information about how the stereo mix was done is available.

Existing 2-to-K channel upmix procedures (i.e., up-scaling of 2 channels into any number of channels K>2) may be classified in two broader classes: ambience generation techniques that attempt to extract or synthesize the ambience of the recording and deliver it to the surround channels, and multi-channel converters that derive additional channels for playback in situations when there are more loudspeakers than channels. More particularly, audio material, such as music or movie material, is typically mixed in standard audio formats, such as stereo, 5.1, 7.1 channel based encodings. However, in many practical situations the reproduction environment is often different compared to that what has been assumed when mixing the material. For example, in one situation, a user may want to listen to stereo material on a surround sound speaker system with more than 2 speakers, or watch a movie encoded in 5.1 on a system which includes additional physical speakers, such as height speakers. Another common application is simply listening to stereo music material on a pair of headphones, although the stereo material has been mixed with the intention of playback on two speakers placed in a room.

As mentioned, a well-known concept is to use upmixing (or remixing) of audio material as a bridge processing step between the encoded format and the actual reproduction system. As an example, a classical upmixing configuration is to receive a stereo input signal and return a 5.1 surround sound signal. Upmixing is not standardized and a variety of upmixing methods exists. Thus, in practice different types of sound experiences are achievable in for example the 2-to-5.1 configuration, and more generally any L-to-K configuration. No clear objective criteria exist and the typical aim of practical upmixing algorithms is to find a setting that provides a good subjective sound experience for any source material. Further information and overview of upmixing and related signal processing algorithms can be found in “Signal Processing for 3D Audio” by Francis Rumsey, Journal of the Audio Engineering Society, Vol. 56, No. 7/8, July/August 2008, and “Spatial audio processing: Upmix, downmix, shake it all about”, Francis Rumsey, Journal of the Audio Engineering Society, Vol. 61, No. 6, 2013 June.

Although the above techniques may sometimes be used with satisfactory results, there is still a general need for improved multi-channel audio processing.

### SUMMARY

In the light of the above, it is a general object to provide new and improved developments with respect to multi-channel audio processing and/or adaptive spatial decoding for upmixing/remixing/downmixing applications. This and other objects will become apparent in the following.

It is a specific object to provide a method for determining a decoding L×K matrix for decoding incoming L-dimensional channel audio into outgoing K-dimensional channel audio where L≥2 and K≥1. There is a further object to provide a method for decoding incoming L-dimensional channel audio into outgoing K-dimensional channel audio using the decoding L×K matrix.

Another object is to provide an adaptive spatial decoder, ASD, configured to decode incoming L-dimensional channel audio into outgoing K-dimensional channel audio. The ASD is sometimes also referred to as an adaptive spatial re-coder.

A method for adaptive spatial decoding, also referred to as adaptive spatial re-coding will also be discussed.

An audio processing system and an overall audio system will also be discussed.

The above and other objects are met by the proposed technology.

Generally, the proposed technology relates to a procedure of configuring, updating or determining a decoding matrix, such as a Multiple-Input-Multiple-Output (MIMO) matrix, for an adaptive spatial decoder to enable improvements for multi-channel audio processing.

Basically, the proposed technology is applicable to multi-channel audio processing related to any 2-to-K channel processing, or even more generally to any L-to-K channel processing such as upmix/remix/downmix processing, where L is an integer equal to or greater than 2 and K is an integer equal to or greater than 1, i.e. L≥2 and K≥1.

Normally K is larger than L (e.g. for upmixing), but K may be equal to L (e.g. for stereo-to-stereo remixing from one stereo format to another) or even smaller than L (e.g. for isolating/extracting certain features or components of the stereo or multi-channel mix such as center channel extraction from stereo), depending on the overall multi-channel audio processing target.

In this way, it is possible to provide improved ways of performing multi-channel audio processing and/or adaptive spatial decoding/recoding for upmixing/remixing/downmixing applications.

According to a first aspect, a method for determining a decoding L×K matrix for decoding incoming L-dimensional channel audio into outgoing K-dimensional channel audio where L≥2 and K≥1 is provided. The method comprising: determining a panning control parameter p and a sample component d that minimizes a first difference metric between an L-dimensional input sample x and an estimation of the input sample x^{est}=d a, where a=A(p) and where A(p) is a first pre-set mapping function that returns an L-dimensional panning vector a for a given panning control parameter p; generating a K-dimensional raw output sample y^{raw}=d s, where s=S(p) and where S(p) is a second pre-set mapping function that returns a K-dimensional panning vector s for a given panning control parameter p, and; determining the decoding L×K matrix M by solving an optimization problem that minimizes a second difference metric between the K-dimensional raw output sample y^{raw} and the decoded input sample x M. The method is preferably a computer implemented method.

Hereby an improved method for multichannel decoding and/or upmixing/remixing/downmixing applications is provided.

It is appreciated that the determining of a panning control parameter p and a sample component d that minimizes a first difference metric between the L-dimensional input sample x and the estimation of the input sample x^{est}=d a may comprise a fitting process. The fitting process may be a deterministic process. An example of such a deterministic process for an incoming stereo signal is discussed in the detailed description under the section Example of raw spatial decoding. Alternatively, the fitting process may comprise solving an optimization problem, that is the panning control parameter p and the sample component d may be determined by solving a first optimization problem that minimizes the first difference metric between the input sample x and the estimation of the input sample x^{est}. This is especially useful in a case when the panning control parameter p is multidimensional such as being the case for ambisonics, where the control parameter p comprises a spatial azimuth and an elevation angle.

The optimization problem of the method may further be set to minimize a sample weighted difference metric. The sample weight may include contributions from other L-dimensional input samples. The weighted difference metric allows for a dynamic update of the decoding L×K matrix, obtained through the weights. The dynamic update may comprise assigning high weight to a current sample and low weights to neighboring samples. The neighboring samples may be neighboring in a time or frequency domain.

The method provides a practical algorithm involving a raw spatial channel estimate in combination with a decoding matrix. In particular, an ASD operates without knowing the underlying number of sources of the signal mixture, thus panning information and/or ambient signal components are not known. The method and the resulting ASD may perform better than standard algorithms, typically based on the primary-ambient modelling and estimation principle, by providing a more stable repanning result, enhanced signal clarity, and generally fewer audible artifacts.

The method may be used in conjunction with an application dependent rendering/routing philosophy of Adaptive spatial decoding (ASD) output channels towards physical speaker channels. The usage/configuration of the ASD module together with the rendering/routing design may constitute a complete upmix experience. Rendering may comprise routing of ASD signals to physical multi-speaker (using gain, delay, decorrelation for example) as in e.g. automotive/home audio applications. Rendering may imply a usage of binaural downmixing of ASD channels in a headphone application.

The first pre-set mapping function A( ) of the method may be pre-set according to a pre-established look-up-table or according to a pre-defined rule conveying information on how to contextually pre-set the mapping function A( ).

The second pre-set mapping function S( ) of the method may be pre-set according to a pre-established look-up-table conveying information on how to contextually set the pre-set mapping function S( ).

Examples of how to choose the predefined mapping functions A(p) and S(p) are provided in the detailed description.

The first difference metric and/or the second difference metric of the method may be determined using an objective cost function. Any one or both of the difference metrics may be determined using a cost function such as weighted absolute difference or weighted squared difference.

The objective cost function of the method may be defined as a weighted square difference. The objective cost function may be a function that minimizes the first and/or the second difference metric. The objective cost function may be defined as a Maximum A Posteriori estimation, MAP, or a Maximum Likelihood, ML, estimation. It is appreciated that the particular form of the objective cost function may originate from the specific kind of estimation sought. The particular form of the objective cost function may advantageously be applied in an optimization problem seeking a decoding L×K matrix.

The method may further comprise splitting the incoming L-dimensional channel audio into a plurality of bands N wherein a decoding L×K matrix is determined for each such band N. Each determined decoding L×K matrix for each such band may be applied per band such that all band outputs may be combined to a K-dimensional time domain signal. The bands may be frequency bands. However, the splitting of bands may also be done in discrete cosine transform (DCT) domain. The splitting of bands may be performed in any suitable domain.

The method may comprise dynamically updating the decoding L×K matrix over time, based on new L-dimensional input samples xᵢ, where i denotes the i'th input sample.

The method may comprise transforming the L-dimensional input sample x from a time domain into another domain. The transformation from a time domain into the another domain may comprise, in the another domain, executing: determining a panning control parameter p and a sample component d that minimizes a first difference metric between an L-dimensional input sample x and an estimation of the input sample x^{est}=d a, where a=A(p) and where A(p) is a first pre-set mapping function that returns an L-dimensional panning vector a for a given panning control parameter p; generating a K-dimensional raw output sample y^{raw}=d s, where s=S(p) and where S(p) is a second pre-set mapping function that returns a K-dimensional panning vector s for a given panning control parameter p, and; determining the decoding L×K matrix M by solving an optimization problem that minimizes a second difference metric between the K-dimensional raw output sample y^{raw} and the decoded input sample x M.

The another domain may be a frequency domain or a combined time/frequency domain. Specific transforms from time domain into the another domain may be a time sliding discrete cosine transform (DCT) or a Short-Time Fourier Transform (STFT).

According to a second aspect, there is provided a non-transitory computer-readable storage medium, having stored thereon instructions for implementing the method according to the first aspect when executed on a device having processing capabilities.

According to a third aspect, there is provided a computer implemented method for decoding incoming L-dimensional channel audio into outgoing K-dimensional channel audio, where L≥2 and K≥1. The method comprising: determining one or more decoding L×K matrices according to the first aspect; and decoding incoming L-dimensional channel audio into outgoing K-dimensional channel audio using the one or more decoding L×K matrices.

The method according to the third aspect may further comprise: transforming the L-dimensional input sample x from a time domain into another domain; while being in the another domain determining the one or more decoding L×K matrices according to the first aspect, and decoding the incoming L-dimensional channel audio into outgoing K-dimensional channel audio using the one or more decoding L×K matrices; and transforming the outgoing K-dimensional channel audio back to the time domain.

According to a fourth aspect, there is provided a non-transitory computer-readable storage medium, having stored thereon instructions for implementing the method according to the third aspect when executed on a device having processing capabilities.

According to a fifth aspect an adaptive spatial decoder, ASD, configured to decode incoming L-dimensional channel audio into outgoing K-dimensional channel audio, where L≥2 and K≥1, is provided. The ASD comprising a plurality of function modules each function module being dedicated to execute a corresponding step in the method according to the third aspect, wherein each individual module is implemented as a hardware module, a software module or a combination thereof.

Other advantages will be appreciated when reading the non-limiting detailed description of the invention.

### BRIEF DESCRIPTION OF DRAWINGS

Further objects and advantages may best be understood by making reference to the following description taken together with the accompanying, non-limiting, appended drawings, in which:

FIG. 1 is a schematic block diagram illustrating a simplified example of an audio system.

FIG. 2 is a schematic diagram illustrating an example of an overview of an audio processing system or chain including an Adaptive Spatial Decoder (ASD) and a rendering module.

FIG. 3 is a schematic diagram illustrating an example of a stereo-to-multichannel processing system or chain including an Adaptive Spatial Decoder (ASD) and a rendering module.

FIG. 4 is a schematic diagram illustrating an example of an Adaptive Spatial Decoder (ASD).

FIG. 5 is a schematic diagram illustrating an application example of an Adaptive Spatial Decoder (ASD) in a specific upmix rendering chain.

FIG. 6 is a schematic diagram illustrating another application example of an Adaptive Spatial Decoder (ASD) in a specific upmix rendering chain.

FIG. 7 is a schematic diagram illustrating yet another application example of an Adaptive Spatial Decoder (ASD) in a specific upmix rendering chain.

FIG. 8 is a schematic diagram illustrating still another application example of an Adaptive Spatial Decoder (ASD) in a specific upmix rendering chain.

FIG. 9A is a schematic diagram illustrating an application example of an Adaptive Spatial Decoder (ASD) in a specific downmix rendering chain for stereo-to-headphone stereo signal.

FIG. 9B is a schematic diagram illustrating an application example of an Adaptive Spatial Decoder (ASD) in a specific downmix rendering chain for multichannel-to-headphone stereo signal.

FIG. 9C is a schematic diagram illustrating an application example of an Adaptive Spatial Decoder (ASD) in a specific remix (or downmix or upmix) rendering chain for multichannel-to-multichannel headphone signal.

FIG. 10 is a schematic diagram illustrating an example of a computer-implementation according to an embodiment.

FIG. 11 is a block diagram of a method for determining a decoding L×K matrix for decoding incoming L-dimensional channel audio into outgoing K-dimensional channel audio where L≥2 and K≥1.

FIG. 12 is a block diagram of a method for decoding incoming L-dimensional channel audio into outgoing K-dimensional channel audio, where L≥2 and K≥1, using the decoding L×K matrix determined as discussed e.g. in connection with FIG. 11.

### DETAILED DESCRIPTION

Throughout the drawings, the same reference designations are used for similar or corresponding elements.

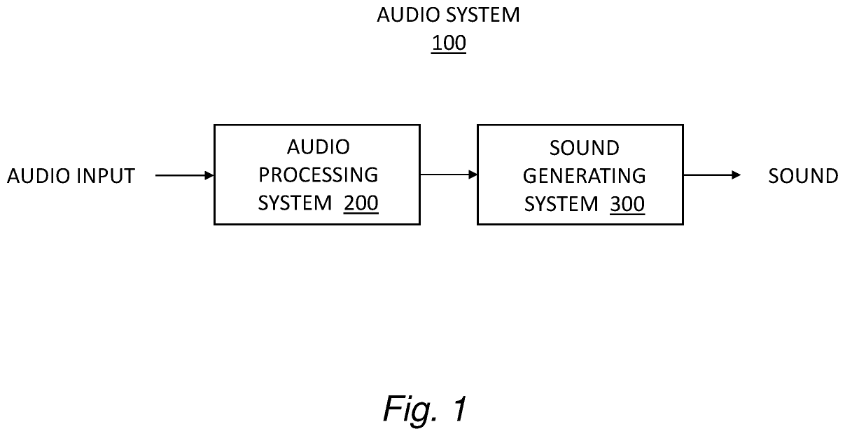

It may be useful to start with an audio system overview with reference to FIG. 1, which illustrates a simplified audio system. The audio system 100 comprises an audio processing system 200 and a sound generating system 300. In general, the audio processing system 200 is configured to process one or more audio input signals which may relate to one or more audio channels. The processed audio signals are forwarded to the sound generating system 300 for producing sound.

As mentioned, a particular type of audio processing concerns multi-channel audio processing for upmixing/remixing/downmixing applications such as stereo-to-multi-channel (2-to-K channel) upmix.

The proposed technology is applicable to multi-channel audio processing related to any 2-to-K channel processing, or even more generally to any L-to-K channel processing such as upmix/remix/downmix processing, where L is an integer equal to or greater than 2 and K is an integer equal to or greater than 1; i.e. L≥2 and K≥1.

Normally K is larger than L (e.g. for upmixing), but K may be equal to L (e.g. for stereo-to-stereo remixing from one stereo format to another) or even smaller than L (e.g. for isolating/extracting certain features or components of the stereo or multi-channel mix such as center channel extraction from stereo), depending on the overall multichannel audio processing target.

In other words, a basic problem is to extract K audio channels from L audio channels, typically (but not necessarily) multiple channels from a lower number of channels (such as the two channels of a stereo audio signal), based on panning information (e.g. level and phase differences) encoded for various sound sources in the original audio signal. In a sense, it is useful to extract signal components based on, or associated with, different panning information or settings.

By way of example, the proposed technology relates to a novel procedure of configuring or determining a decoding matrix such as a Multiple-Input-Multiple-Output (MIMO) matrix for an adaptive spatial decoder to enable improvements for multi-channel audio processing.

The proposed technology will now be described with illustrative reference to adaptive spatial decoding, as a procedure for multi-channel audio processing, as well as to an Adaptive Spatial Decoder (ASD) as a central component in a multi-channel audio processing system. In a particular use case, the ASD module may be provided as a plugin that can be used, e.g. by mixing engineers and/or music producers. By way of example, the following short explanation of the key terms of the Adaptive Spatial Decoder (ASD) may be given for facilitated understanding:
Adaptive
   normally refers to the fact that the module tracks certain input/source channel (e.g. Left/Right for stereo input) statistics of the source signal and continuously adapts the decoding matrix or matrices.
Spatial
   normally refers to a spatial interpretation of panning positions, where the source channels (e.g. Left/Right for stereo input) are typically associated with physical speaker positions. Where it is understood that such panning and/or speaker positions can be expressed in one-, two- and/or three-dimensions.
Decoding
   normally refers to the well-accepted concept of passive/active matrix decoding in upmixing/remixing/downmixing applications, e.g. see “Multichannel matrix surround decoders for two-eared listeners” by David Griesinger, presented at the 101st Audio Engineering Society Convention, Los Angeles, November 1996. Audio Engineering Society, 1996. By way of example, the ASD module can be seen as a type of active matrix decoding.

The Adaptive Spatial Decoder (ASD) is sometimes also referred to as a re-coder.

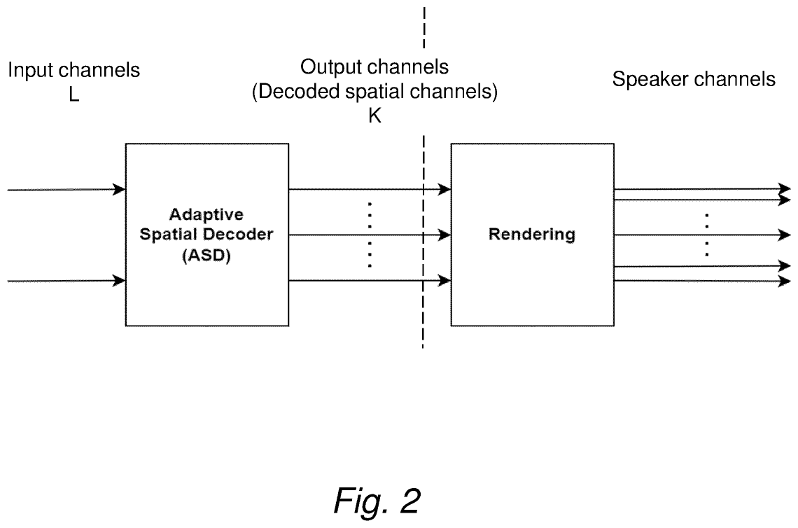

FIG. 2 is a schematic diagram illustrating an example of an overview of an audio processing system or chain including an Adaptive Spatial Decoder (ASD) and a rendering module.

The Adaptive Spatial Decoder (ASD) may receive L input or source channels (such as a stereo input) and generate K output channels based on one or more decoding matrices. The K output channels may be regarded as decoded spatial channels.

The Adaptive Spatial Decoder (ASD) can be used in conjunction with an application-dependent rendering, e.g. an application-dependent routing of ASD output channels towards physical speaker channels, as in e.g. automotive or home audio applications, or it can imply the usage of binaural downmixing of ASD channels in a headphone application.

By way of example, the Adaptive Spatial Decoder (ASD) can be used in conjunction with an application-dependent rendering to create stereo-to-standard-surround upmixing chains such as stereo-to-5.1 and stereo-to-7.1.

The proposed technology also provides an audio processing system comprising such an Adaptive Spatial Decoder (ASD) and/or multi-channel audio processing system.

The proposed technology further provides an overall audio system comprising such an audio processing system.

For a better understanding, a more detailed but non-limiting discussion and disclosure of implementations will now be given:

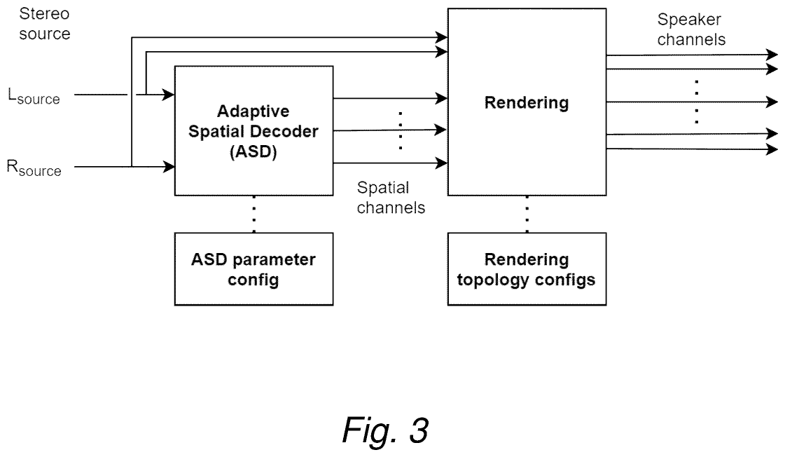

FIG. 3 is a schematic diagram illustrating an example of a stereo-to-multichannel processing system or chain including an Adaptive Spatial Decoder (ASD) and a rendering module.

In this example, the ASD module is configured to analyze a 2-channel stereo signal (L_{source}/R_{source}; Left/Right) and return a configurable set of “spatial channels” (e.g. up to 7) corresponding to different Left/Right input correlations (e.g. interpreted as panning angles).

Optionally, the ASD module may be configured to return uncorrelated or decorrelated channels aiming at removing or at least significantly reducing (e.g. Left/Right) correlated content from the source signal.

In general, the ASD module is intended to be used in conjunction with an application dependent rendering and/or routing philosophy of ASD output channels towards physical speaker channels. The usage and/or configuration of the ASD module together with the rendering and/or routing design then constitute a complete “upmix/remix experience”.

By way of example, rendering can mean routing of ASD signals to multiple physical speakers (using gain, delay, filtering for example) as in e.g. automotive or home audio applications, or it can imply the usage of binaural downmixing of ASD channels in a headphone application, as will be explained in more detail later on. It should be understood that the invention is not limited to stereo applications, but is generally valid and applicable for any L-to-K channel processing, as previously discussed.

An example of possible configuration and/or operating principles is outlined below:
1. Select processing domain—remain in the time domain or use a suitable transform of the audio signal, for example:
   Filterbank using Short-Time Fourier Transform (STFT) processing (time/frequency domain).
   No transform (operate directly in time domain).
   Some other time and/or frequency analysis and/or synthesis chain.
2. Compute a raw spatial channel decoding yᵢ (K-dimensional) per audio observation sample xᵢ (L-dimensional) in the transformed domain:
   Note, K can be smaller, have the same value, or be larger than L, depending on what the target is.
3. Compute MIMO decoding matrices given the observation samples and the associated raw spatial channel decoding samples.
4. Apply MIMO decoding matrices to the observation samples in the selected and/or transformed domain (and possibly apply inverse transform to go back to the time domain) to produce the final K-dimensional output signal.

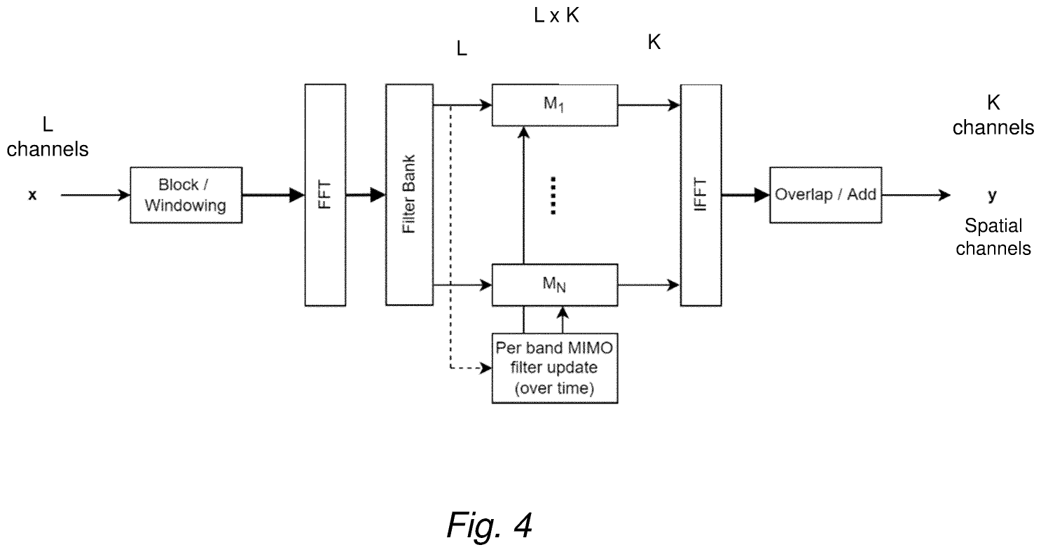

FIG. 4 is a schematic diagram illustrating an example of an Adaptive Spatial Decoder (ASD).

By way of example, the Adaptive Spatial Decoder (ASD) may include a block/windowing module, a Fast Fourier Transform (FFT) module and a filter bank according to well-accepted technology.

Further, the Adaptive Spatial Decoder (ASD) may include a set of decoding matrices M₁ to M_{N}, one for each of N bands, each decoding matrix being a L×K decoding matrix. Each one or any (one or more) of the decoding matrices may be continuously updated, if desired, over time in response to the input. It should be understood that the L×K decoding matrix is not limited to constitute only row or only column vectors. In other words, the L×K decoding matrix may be a K×L decoding matrix.

The Adaptive Spatial Decoder (ASD) may further include an IFFT module configured for inverse-transformation of the output channels, per band, as well as a conventional overlap/add module to generate K output channels, which may be decoded spatial channels y and optionally additional uncorrelated channels.

The panning interpretation and/or transformation target may be seen as a redistribution of the input audio signal into a multi-channel sound field.

For example, for a stereo signal, when the Left-channel (L_{source}) audio samples equal the Right-channel (R_{source}) audio samples, this is intended to be perceived as a phantom center source (between the two physical speakers). Such material is referred to as “center panned” material. A possible transformation (mapping) target in this case can be to output a channel dedicated for center panned material with some chosen panning granularity. Amplitude panning can also be used in conjunction with the proposed technology, e.g. sin-cosine-based panning, see “Multichannel matrix surround decoders for two-eared listeners” by David Griesinger, presented at the 101st Audio Engineering Society Convention, Los Angeles, November 1996. Audio Engineering Society, 1996.

Additional information on panning can be found, e.g. in “Virtual sound source positioning using vector base amplitude panning” by Pulkki, Ville, Journal of the audio engineering society 45.6:456-466, 1997.

### Example of Raw Spatial Channel Decoding

By way of example, the raw spatial channel decoding function may take a view that the sample xᵢ is arising from a mono signal mapped to the source dimensions, i.e.

$${x}_{i} = {a}_{i} {d}_{i}$$

where aᵢ is a (normalized) real-valued 1×L panning/encoding vector belonging to some set A, dᵢ is the primary signal component (scalar/mono), and i denotes the i'th index/sample.

From just a single observation sample xᵢ it is possible to find the value of aᵢ in A (and the associated signal dᵢ) that describes the observation (note the set A is such that there is no sign ambiguity). When L=2 (stereo), this may be achieved via trigonometric identities assuming aᵢ belongs to a set of cos-sin panning vectors A. As an example, for a stereo sample vector xᵢ which has the same value in both entries of xᵢ, the associated panning vector aᵢ can be determined to be [cos(π/4) sin(π/4)]=[1 1]/√2, corresponding to a center panned sample.

The following procedure defines an example of raw spatial channel decoding:
1. Find the normalized panning/encoding vector
   aᵢ given xᵢ
2. Estimate the associated mono signal component

$${d}_{i}^{est} = {x}_{i} {a}_{i}^{T}$$

3. Determine (for example by a predetermined look-up table, or some “rule”) the K-dimensional mapping associated with aᵢ
   sᵢ=S(aᵢ), where S( ) is a mapping function (e.g. a look-up table containing a set S including a finite (quantized) number of vectors sᵢ) describing how to translate/decode a given L-dimensional encoding vector into a K-dimensional output vector
4. Map the estimated mono signal component to the final raw spatial channel decoded output

$${y}_{i}^{raw} = {s}_{i} {d}_{i}^{est}$$

The set S and the mapping function S( ) can also, respectively, be regarded as a set or function that describes how to translate and/or decode a given L-dimensional encoding vector aᵢ into a K-dimensional output vector sᵢ.

As an example, assume L=2 (stereo) and K=3, with the target of providing output channels Lₛₚₐₜᵢₐₗ, Cₛₚₐₜᵢₐₗ, Rₛₚₐₜᵢₐₗ, and consider the beforementioned case of a center panned sample aᵢ=[1 1]/√2. The associated mapping function S( ) can conveniently be chosen to return a 3-speaker panning vector sᵢ=S(aᵢ)=[0 1 0] for aᵢ=[1 1]/√2. Corresponding to a target of redistributing center panned stereo material to the Cₛₚₐₜᵢₐₗ channel only. In general, the multi-channel redistribution target for any value aᵢ may be captured in S( ), e.g. according to multi-channel panning rules.

Importantly, the mapping function S( ) can for example be flexibly shaped, and generally provides a direct mechanism for designing and/or choosing the desired spatial decoding behavior. In other words, the mapping function S( ) is configurable for selectively and/or adaptively determining the spatial decoding behavior.

### Example of MIMO Decoding Matrix Computation

The MIMO decoding matrix (per band) may be computed based on observation samples and the associated raw spatial decoding samples with the general principle being:
For a set of observation samples xᵢ and raw spatial decoding samples yᵢ^{raw}, compute the decoding matrix M that provides the best estimate (or weighted estimate) xᵢ*M of the raw spatial estimate yᵢ^{raw}.

For example, in the form of a weighted least squares estimate:
M_{dec}=arg min_{M} sumᵢ wᵢ∥xᵢ M−yᵢ^{raw}∥² where wᵢ is a (non-negative) weight associated with the i^{th} sample.

The signal domain in which the MIMO decoding matrix is computed is however flexible, and different modes of operation are possible:
1. The decoding matrix may be computed in the transformed domain in which the raw spatial decoding samples are computed by using the data (observation+raw spatial) belonging to the transformed domain.
   For example, xᵢ and yᵢ^{raw} are samples from multiple STFT windows associated with a specific frequency or discrete cosine transform (DCT) band.
2. The decoding matrix may be computed in the original time domain based on original observations and inversely transformed raw spatial decoding samples.
3. The decoding matrix may be computed in a secondary transform domain by applying a secondary transform to the observations+raw spatial decoding samples.

By way of example, for linear transforms, it is possible to generalize this for the least square principle as:

$${M}_{dec} = arg {min}_{M} Tr [ {( XM - {Y}^{raw} )}^{T} {U}^{T} U ( X M - {Y}^{raw} ) ]$$

where U is a generalized weight/transform matrix mapping a set of samples to another domain, and where X (size Nᵢ×L) and Y^{raw} (size Nᵢ×K) are matrices containing a set of (row-vector) samples, where Nᵢ is the number of samples in the set.

In a particular, non-limiting example, related to stereo-to-multichannel processing, the ASD module may be configured as follows:
The module processes a 2-channel (stereo) input signal returning, e.g. 7+2 output channels
Input
   2 channels (Left/Right stereo)
Output
   For example, 7 spatial channels:
      Aims to repan the stereo source to more than two channels according to the configuration loaded, i.e. according to a mapping function S( ), which specifies for any source panning vector aᵢ, from a set A, the associated 7-dimensional repanning vector, sᵢ, from the set S.
   Optionally, e.g. 2 uncorrelated channel estimates:
      Aims to estimate the uncorrelated signal components in the stereo signal for potential usage as “source ambience enhancement”.
      Can also be seen as “correlated signal attenuator”, e.g. center panned material will be heavily attenuated.
Key parameters
   A set of one or more parameters with a certain degree of configurability.
      For example, sample weights used for updating the decoding matrices. Alternatively, a meta parameter controlling the sample weights, such as a temporal “forgetting factor”.
      In particular, a panning control parameter p, interpreted as one or multiple angles or indices associated with the stereo source.
      Additional parameter(s) can relate to the configuration of the filterbank, such as the number of bands and their frequency or DCT ranges.
   Spatial channel configuration, i.e. spatial channel mapping function.
      Carrying the Spatial channel MAP (SMAP) matrix determining a basic spatial channel repanning rule. The SMAP may be carrying configurable instructions (e.g. in the form of a panning control parameter p) for repanning to multiple spatial channels. This may correspond to the set S, which specifies the basic spatial channel decoding (repanning) rule associated with any source panning vector from a set A. For example, when L=2 (stereo), the set A may contain cosine-sine panning vectors and for K=7, the set S may contain the associated repanning vectors for e.g. 7 discrete speakers. In other words, a panning control parameter p may define the panning vectors s and/or a from its correspondence to the sets S and A.

### Example of Audio Path

STFT core implementing an N-band filterbank (running convolution principle), and per band MIMO filtering.
The per band MIMO filter is a 2×9 filter
   9=7 spatial+2 uncorrelated channel filters updated dynamically over time adapting its behavior to the content of the stereo source signal.

### Example of MIMO Filter Matrix Design

By way of example, the core of the ASD module involves the design of the MIMO filter matrix, here exemplified by a 2×9 MIMO matrix. As previously indicated, the overall matrix may include or be split into two components, one 2×7 matrix M^{s} for the 7 spatial channels output, and another optional component, i.e. a 2×2 matrix M^{u} for the 2 uncorrelated channels output.
Update spatial channel MIMO filter M^{s} (2×7 filter) using a Least Squares decoding Matrix (LSM) principle:
   1. Compute raw spatial channel estimates yᵢ^{raw} independently for the samples in the transformed groups (each FFT bin, real and imaginary components for a time/frequency group, i.e. band over some duration in time)
      a. Select an initial transformation (e.g. the STFT Filterbank transform) where the different sources/components in the (stereo) mix separate reasonably well, i.e. the different sources/components in the (stereo) mix are separate to some definable extent.
   2. Update MIMO filters for each band n by fitting a MIMO matrix Mₙ such that, for a set of audio samples x_{i,n} (samples for a given band over some time), the expansion of stereo signal x_{i,n} to 7 spatial channels by the MIMO filter (x_{i,n}*Mₙ) approximates the raw spatial estimate y_{i,n}^{raw}
      a. This can be done by solving a least squares problem for each band with decaying weights on samples from previous time windows, conceptually like
      b. M^{s}ₙ=arg min_{M} sumᵢ wᵢ∥x_{i,n} M−y_{i,n}^{raw}∥² which leads to
      c. M^{s}ₙ=inv(Pₙ) Qₙ, where Pₙ=sumᵢ wᵢ (x_{i,n})^{T}x_{i,n} is a 2×2 matrix and Qₙ=sumᵢ wᵢ (x_{i,n})^{T}y_{i,n}^{raw} is a 2×7 matrix.
      d. In practice Pₙ and Qₙ for each band n may be tracked over time.
Optionally, update the uncorrelated channel MIMO filter M^{u} (2×2 filter), for example using LMMSE principles.
   This type of estimation is based on another model/view on the stereo source signal with the purpose of providing output channels that may be applied for “ambient” signal enhancement in an upmix chain.
   View the stereo signal (locally in time and frequency) as
      xᵢ=aᵢ dᵢ+vᵢ
      where aᵢ is a real-valued 1×2 panning vector, dᵢ is the primary signal component (scalar), and vᵢ is a 1×2 vector representing a Left/Right uncorrelated ambient component
   The aim is to output an estimate of the signal vᵢ (without knowing aᵢ and dᵢ).
   A linear estimate of vᵢ using a MIMO matrix M^{u} can be obtained by

$${v}_{i}^{est} = {x}_{i} ⋆ {M}^{u}$$

The Linear Minimum Mean Square Error (LMMSE) estimate of matrix M^{u}ₙ for band n can be shown to be
   M^{u}ₙ=E[vₙ^{T}xₙ] inv (E[xₙ^{T}xₙ]), where E[ ] is the expectation operator.

Useful implementations and/or configurations may be based on the realization that sources/components generally separate better in joint time/frequency domain (with suitable time and/or frequency resolution). For example, a choice of configuration may be based on testing various configurations and performing listening tests to enable selection of a configuration that gives good results.

In a sense, the proposed technology may be based on a new way of computing and/or updating one or more decoding MIMO matrices, e.g. each decoding matrix being dynamically updated or adapted in a recursive least squares sense.

Slightly differently expressed, the proposed technology may be seen as a filterbank-based STFT LSM adaptive panning or repanning procedure. By way of example, the STFT LSM procedure enables utilization of raw FFT bins and/or samples to obtain a high time/frequency resolution view on the source material (of the input signal), and allows performing raw repanning in this domain, while using LSM decoding matrix filtering on top for robustification. For example, using high resolution raw spatial channel estimates as training data (fitting data) for a Least Squares decoding Matrix filterbank architecture leads to both a robust and high quality spatial channel output.

By way of example, this gives the ability to repan two non-orthogonal sources within a time/frequency slot. For example, in a system with stereo input, this gives the ability to identify and perform a raw remapping (i.e. repanning) of two non-orthogonal sources (using the high resolution time/frequency view) and obtain a decoding matrix that preserves the repanning (robustly) of two non-orthogonal sources within a (lower resolution) time/frequency slot, such as within one frequency band seen over a certain time duration.

Technical benefits, especially when applied in an overall rendering chain, may include improvements with respect to, e.g., reduced audio artifacts, and more implementation-friendly configurations in terms of latency reduction.

As should be understood, the ASD module plays a central role in the overall upmix/remix/downmix chain, non-limiting examples of which will be described in the following.

Potential applicability may include one or more of the following:
Front stage control.
   Widening of sweet-spot (casual listening)
   Stabilization of center voice (dialogue enhancement)
   Deal with non-ideal reproduction environments
   Multi speaker widening of the sound stage
Creating a sensation of envelopment.

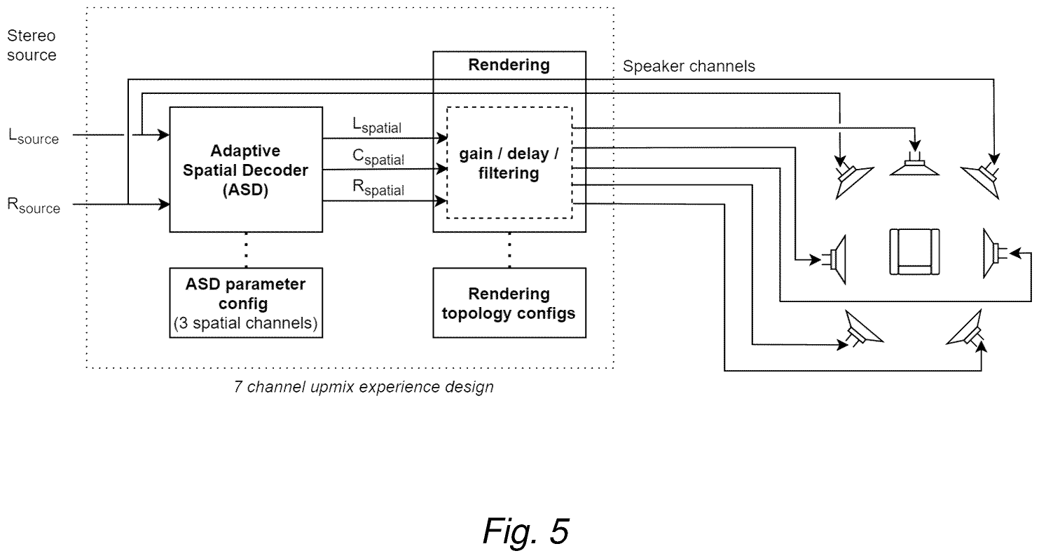

FIG. 5 is a schematic diagram illustrating an application example of an Adaptive Spatial Decoder (ASD) in a specific upmix rendering chain.

In this example, a home audio scenario is illustrated. By way of example, it may be desirable to use normal stereo front stage (phantom center), e.g. to create immersion by feeding chosen components of the stereo mix to other available speakers.

For the upmix chain, it is for example possible to use the stereo source on the front Left/Right speakers, configure the ASD module to output Lₛₚₐₜᵢₐₗ-Rₛₚₐₜᵢₐₗ-Cₛₚₐₜᵢₐₗ decoded channels, and use only Lₛₚₐₜᵢₐₗ and Rₛₚₐₜᵢₐₗ to other speakers for immersion in the content of these channels, i.e. side-panned material—while not distributing Cₛₚₐₜᵢₐₗ (to avoid center vocal disturbances).

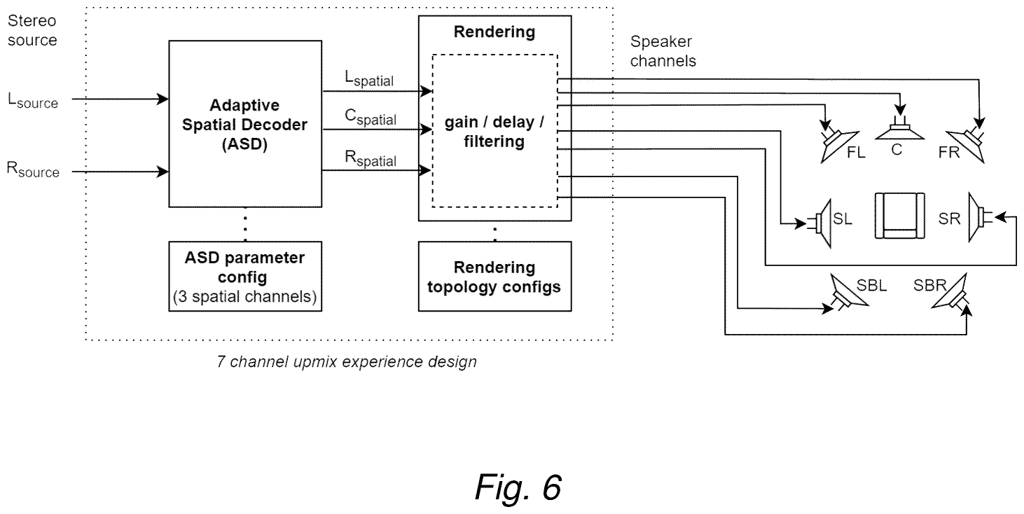

FIG. 6 is a schematic diagram illustrating another application example of an Adaptive Spatial Decoder (ASD) in a specific upmix rendering chain.

In this example, another home audio scenario is illustrated. By way of example, it may be desirable to use a 3-speaker front stage (stabilized, widened and/or sweet spot), e.g. to create immersion by feeding chosen decoded components of the stereo mix to other available speakers.

For the upmix chain, it is for example possible to configure the ASD module to output the spatial decoded channels Lₛₚₐₜᵢₐₗ, Cₛₚₐₜᵢₐₗ, and Rₛₚₐₜᵢₐₗ, and feed these to front speakers for physical center experience, and feed a filtered version of Lₛₚₐₜᵢₐₗ and Rₛₚₐₜᵢₐₗ to other speakers for immersion in the content of these channels, i.e. side-panned material.

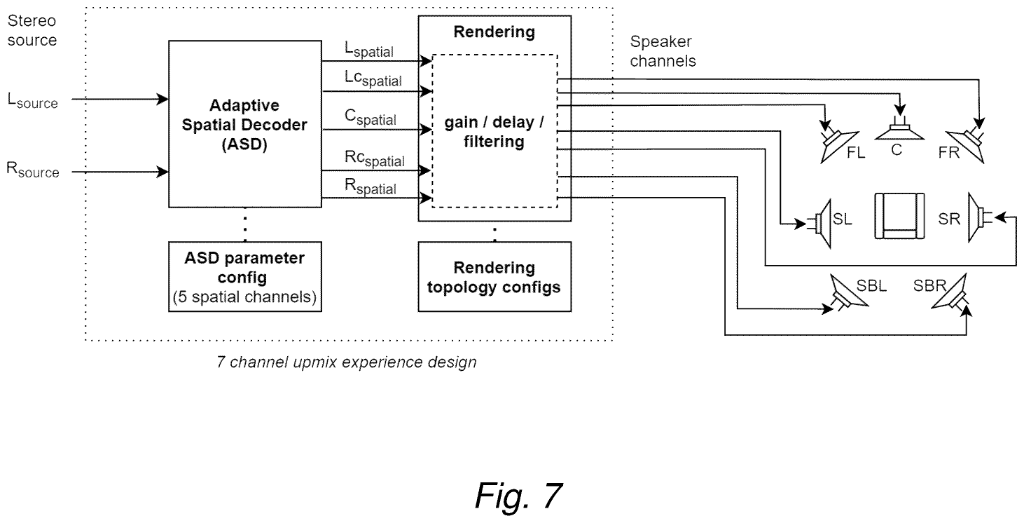

FIG. 7 is a schematic diagram illustrating yet another application example of an Adaptive Spatial Decoder (ASD) in a specific upmix rendering chain.

In this example, yet another home audio scenario is illustrated. By way of example, it may be desirable to use a 5-speaker front stage for an in-the-band immersion experience. Alternatively, one could also have a configuration with 5 speakers on a wall for a wide and stable stage experience.

For the upmix chain, it is for example possible to configure the ASD module to output 5 front Lₛₚₐₜᵢₐₗ-Lcₛₚₐₜᵢₐₗ-Cₛₚₐₜᵢₐₗ-Rcₛₚₐₜᵢₐₗ-Rₛₚₐₜᵢₐₗ spatial decoded channels, and manipulate these channels as a part of the rendering experience before feeding the signals to a surround system.

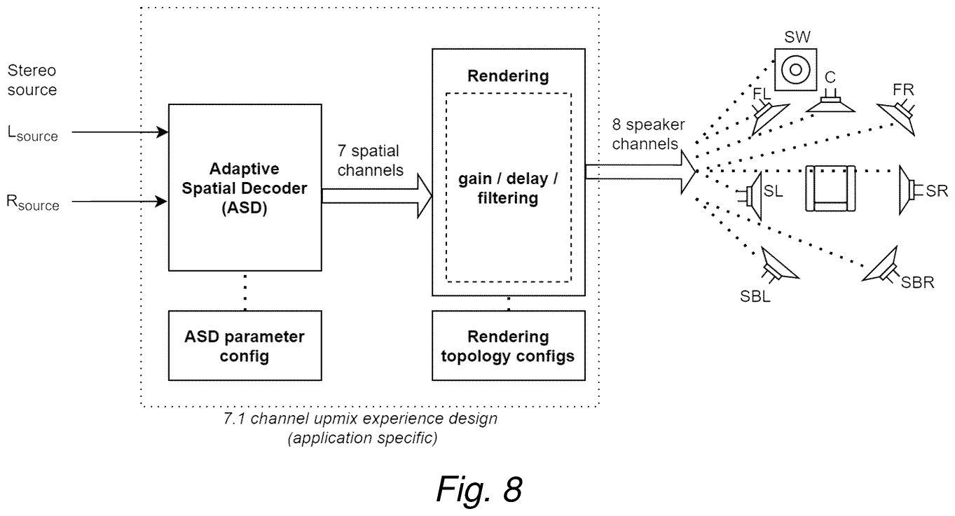

FIG. 8 is a schematic diagram illustrating still another application example of an Adaptive Spatial Decoder (ASD) in a specific upmix rendering chain. This example is similar to that of FIG. 7, but here also including one or more extensions, e.g. to a surround system with one or more subwoofers (SW).

It should also be understood that other variations are also possible, e.g. the surround system may have height speakers too. An example may be a 7.x.4 layout.

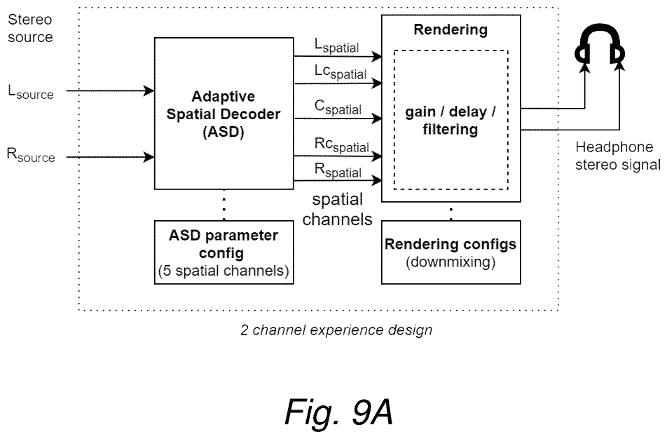

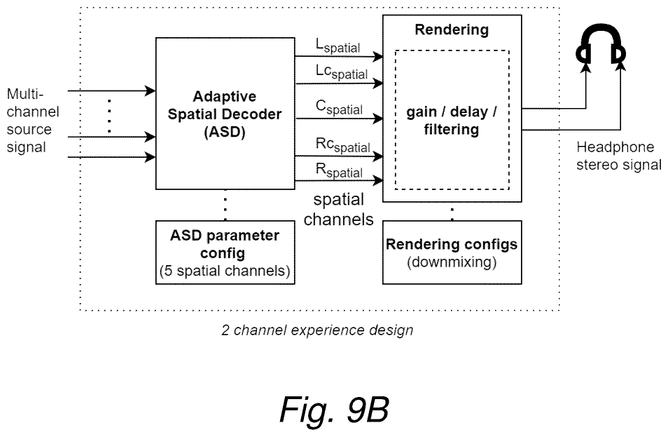

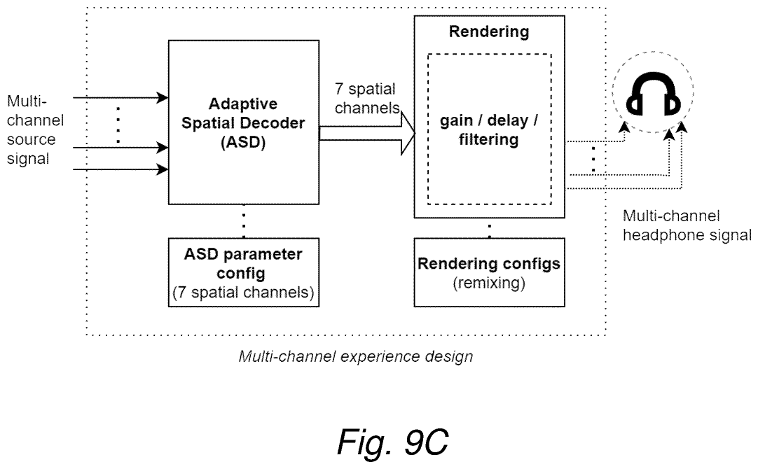

FIG. 9A is a schematic diagram illustrating an application example of an Adaptive Spatial Decoder (ASD) in a specific remix/downmix rendering chain for stereo-to-headphone stereo signal. For example, binaural downmixing may be a special case.

FIG. 9B is a schematic diagram illustrating an application example of an Adaptive Spatial Decoder (ASD) in a specific downmix rendering chain for multichannel-to-headphone stereo signal.

FIG. 9C is a schematic diagram illustrating an application example of an Adaptive Spatial Decoder (ASD) in a specific upmix/remix/downmix rendering chain for multichannel-to-multichannel headphone signal.

In the above rendering examples, it should be understood that rendering may involve, e.g. processing based on gain and/or delay and/or various filtering operations.

As mentioned, the ASD module may optionally be configured to return uncorrelated or decorrelated channels aiming at removing or at least significantly reducing correlated content from the source signal, as a complementary aspect to the basic decoding functionality of the ASD.

When integrating the overall signal architecture, it may be convenient to compute both the spatial decoding matrix and the uncorrelated decoding matrix and merge them into a combined decoding matrix, thus providing outputs of different nature in a single processing framework.

When using ASD in a rendering context (such as an upmix/remix/downmix application) it may or may not be that both the spatial channels and the uncorrelated channels are used in combination.

It should thus be understood that it is clearly possible to use the ASD module without uncorrelated channels. It is also possible to use an ASD module that generates both spatial channels and uncorrelated channels.

It will be appreciated that the methods and arrangements described herein can be implemented, combined and re-arranged in a variety of ways.

By way of example, there is provided an apparatus configured to perform the method as described herein.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

It is also possible to provide a solution based on a combination of hardware and software. The actual hardware-software partitioning can be decided by a system designer based on a number of factors including processing speed, cost of implementation and other requirements.

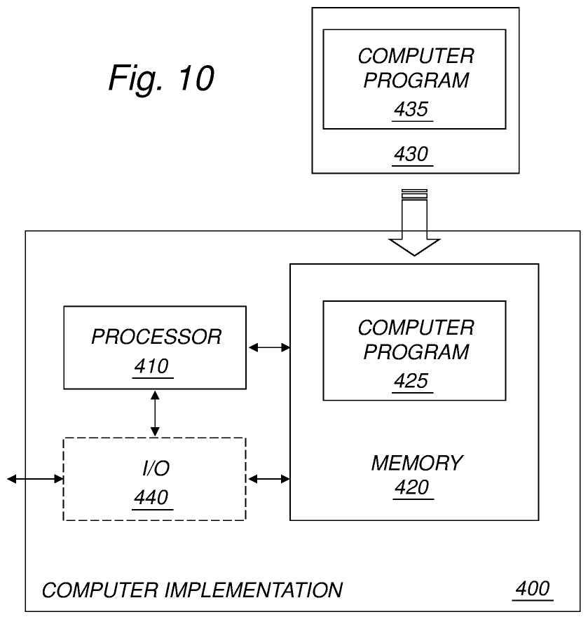

FIG. 10 is a schematic diagram illustrating an example of a computer-implementation 400. In this particular example, at least some of the steps, functions, procedures, modules and/or blocks described herein are implemented in a computer program 425; 435, which is loaded into the memory 420 for execution by processing circuitry including one or more processors 410. The processor(s) 410 and memory 420 are interconnected to each other to enable normal software execution. An optional input/output device 440 may also be interconnected to the processor(s) 410 and/or the memory 420 to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors 410 is thus configured to perform, when executing the computer program 425, well-defined processing tasks such as those described herein.

The processing circuitry does not have to be dedicated to only execute the above-described steps, functions, procedure and/or blocks, but may also execute other tasks.

In a particular embodiment, the computer program 425; 435 comprises instructions, which when executed by the processor 410, cause the processor 410 to perform the tasks described herein.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

By way of example, the software or computer program 425; 435 may be realized as a computer program product, which is normally carried or stored on a non-transitory computer-readable medium 420; 430, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

The procedural flows presented herein may be regarded as a computer flows, when performed by one or more processors 410. A corresponding apparatus may be defined as a group of function modules, where each step performed by the processor 410 corresponds to a function module. In this case, the function modules are implemented as a computer program running on the processor 410.

The computer program residing in memory 420 may thus be organized as appropriate function modules configured to perform, when executed by the processor 410, at least part of the steps and/or tasks described herein.

Alternatively, it is possible to realize the function modules predominantly by hardware modules, or alternatively by hardware, with suitable interconnections between relevant modules. Particular examples include one or more suitably configured digital signal processors and other known electronic circuits, e.g. discrete logic gates interconnected to perform a specialized function, and/or Application Specific Integrated Circuits (ASICs) as previously mentioned. Other examples of usable hardware include input/output (I/O) circuitry and/or circuitry for receiving and/or sending signals. The extent of software versus hardware is purely implementation selection.

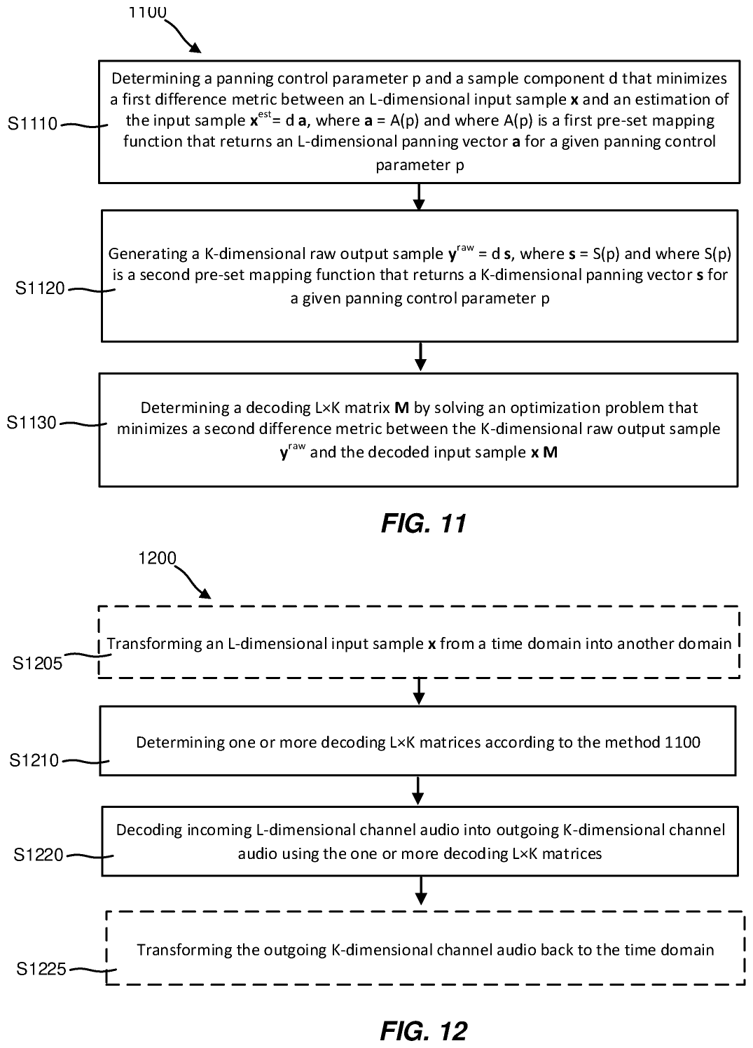

In connection with FIG. 11 a method 1100 for method for determining a decoding L×K matrix for decoding incoming L-dimensional channel audio into outgoing K-dimensional channel audio, where L≥2 and K≥1, will be discussed. The method may be computer implemented, that is steps, or differently expressed function modules, of the method is preferably executed by a processor. However, just as discussed above one or more steps/function modules of the method may be implemented in hardware. Some or all the steps of the method 1100 may be performed by the ASD described above. However, it is equally realized that some or all of the steps of the method 1100 may be performed by one or more other devices having similar functionality. The method 1100 comprises the following steps. The steps may be performed in any suitable order.

Determining S1110 a panning control parameter p and a sample component d that minimizes a first difference metric between an L-dimensional input sample x and an estimation of the input sample x^{est}=d a, where a=A(p) and where A(p) is a first pre-set mapping function that returns an L-dimensional panning vector a for a given panning control parameter p. As has been discussed in more detail above, the first pre-set mapping function A( ) may be pre-set according to a pre-established look-up-table or according to a pre-defined rule conveying information on how to contextually pre-set the mapping function A( ) As has been discussed in more detail above, the first difference metric may be determined using an objective cost function. For example, the objective cost function may be defined as a weighted square difference.

Generating S1120 a K-dimensional raw output sample y^{raw}=d s, where s=S(p) and where S(p) is a second pre-set mapping function that returns a K-dimensional panning vector s for a given panning control parameter p. As has been discussed in more detail above, the second pre-set mapping function S( ) may be pre-set according to a pre-established look-up-table conveying information on how to contextually set the pre-set mapping function S( ).

Determining S1130 the decoding L×K matrix M by solving an optimization problem that minimizes a second difference metric between the K-dimensional raw output sample y^{raw} and the decoded input sample x M. As has been discussed in more detail above, the optimization problem may be set to minimize a sample weighted difference metric wherein a sample weight includes contributions from other L-dimensional input samples. As has been discussed in more detail above, the second difference metric may be determined using an objective cost function. For example, the objective cost function may be defined as a weighted square difference.

The method 1100 may further comprise a step of splitting the incoming L-dimensional channel audio into a plurality of bands N wherein a decoding L×K matrix is determined for each such band N. The splitting of the incoming L-dimensional channel audio into a plurality of bands N has been discussed in more detail above.

The method may further comprise a step of dynamically updating the decoding L×K matrix over time based on new L-dimensional input samples xᵢ, where i denotes the i'th input sample. The dynamic updating of the decoding L×K matrix over time has been discussed in more detail above.

The method may further comprise a step of transforming the L-dimensional input sample x from a time domain into another domain. The executing steps S1110, S1120 and 1130 is then preferably performed in the another domain. As discussed above the another domain may be a frequency domain or a combined time/frequency domain.

In connection with FIG. 12 a method 1200 for decoding incoming L-dimensional channel audio into outgoing K-dimensional channel audio, where L≥2 and K≥1, will be discussed. The method may be computer implemented, that is steps, or differently expressed function modules, of the method is preferably executed by a processor. However, just as discussed above one or more steps/function modules of the method may be implemented in hardware. Some of all the steps of the method 1200 may be performed by the ASD described above. However, it is equally realized that some or all of the steps of the method 1200 may be performed by one or more other devices having similar functionality. The method 1200 comprises the following steps. The steps may be performed in any suitable order.

Determining S1210 one or more decoding L×K matrices. The one or more decoding L×K matrices being determined as being discussed above, especially as being discussed in connection with the method discussed in connection with FIG. 11.

Decoding S1220 incoming L-dimensional channel audio into outgoing K-dimensional channel audio using the one or more decoding L×K matrices.

The method 1200 may further comprise transforming S1205 the L-dimensional input sample x from a time domain into another domain. As was discussed in more detail above, the another domain may be a frequency domain or a combined time/frequency domain. While being in the another domain performing the steps of determining S1210 the one or more decoding L×K matrices and decoding S1220 the incoming L-dimensional channel audio into outgoing K-dimensional channel audio using the one or more decoding L×K matrices.

The method 1200 may further comprise transforming S1225 the outgoing K-dimensional channel audio back to the time domain.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

1. A computer implemented method for determining a decoding L×K matrix for decoding incoming L-dimensional channel audio into outgoing K-dimensional channel audio where L≥2 and K≥1, the method comprising the following steps:
a) determining a panning control parameter p and a sample component d that minimizes a first difference metric between an L-dimensional input sample x and an estimation of the input sample x^{est}=d a, where a=A(p) and where A(p) is a first pre-set mapping function that returns an L-dimensional panning vector a for a given panning control parameter p;
b) generating a K-dimensional raw output sample y^{raw}=d s, where s=S(p) and where S(p) is a second pre-set mapping function that returns a K-dimensional panning vector s for a given panning control parameter p;
c) determining the decoding L×K matrix M by solving an optimization problem that minimizes a second difference metric between the K-dimensional raw output sample y^{raw} and the decoded input sample x M.

2. The method according to claim 1, wherein the optimization problem is set to minimize a sample weighted difference metric wherein a sample weight includes contributions from other L-dimensional input samples.

3. The method according to claim 1, wherein the first pre-set mapping function A( ) is pre-set according to a pre-established look-up-table or according to a pre-defined rule conveying information on how to contextually pre-set the mapping function A( ).

4. The method according to claim 1, wherein the second pre-set mapping function S( ) is pre-set according to a pre-established look-up-table conveying information on how to contextually set the pre-set mapping function S( ).

5. The method according to claim 1, wherein the first difference metric and/or the second difference metric is determined using an objective cost function.

6. The method according to claim 5, wherein the objective cost function is defined as a weighted square difference.

7. The method according to claim 1, further comprising a step of splitting the incoming L-dimensional channel audio into a plurality of bands N wherein a decoding L×K matrix is determined for each such band N.

8. The method according to claim 1, further comprising a step of dynamically updating the decoding L×K matrix over time based on new L-dimensional input samples xᵢ, where i denotes the i'th input sample.

9. The method according to claim 1, further comprising a step of transforming the L-dimensional input sample x from a time domain into another domain, and executing steps a)-c) in the another domain.

10. The method according to claim 9, wherein the another domain is a frequency domain or a combined time/frequency domain.

11. A non-transitory computer-readable storage medium having stored thereon instructions for implementing the method according to claim 1, when executed on a device having processing capabilities.

12. A computer implemented method for decoding incoming L-dimensional channel audio into outgoing K-dimensional channel audio, where L≥2 and K≥1, the method comprising the following steps:
determining one or more decoding L×K matrices according to claim 1, and
decoding incoming L-dimensional channel audio into outgoing K-dimensional channel audio using the one or more decoding L×K matrices.

13. The method according to claim 12, further comprising the following steps:
transforming the L-dimensional input sample x from a time domain into another domain;
wherein the one or more decoding L×K matrices are determined in the another domain, and wherein the incoming L-dimensional channel audio is decoded in the another domain into outgoing K-dimensional channel audio using the one or more decoding L×K matrices; and
transforming the outgoing K-dimensional channel audio back to the time domain.

14. A non-transitory computer-readable storage medium having stored thereon instructions for implementing the method according to claim 12, when executed on a device having processing capabilities.

15. An adaptive spatial decoder, ASD, configured to decode incoming L-dimensional channel audio into outgoing K-dimensional channel audio, where L≥2 and K≥1, the ASD comprising a plurality of function modules each function module being dedicated to execute a corresponding step in the method according to claim 12, wherein each individual module is implemented as a hardware module, a software module or a combination thereof.

16. K dimensional channel audio generated according to the method of claim 12, where K≥1.
